(19) United States
(12) Patent Application Publication
(10) Pub. No.: US 2011/0225576 A1
(43) Pub. Date: Sep. 15, 2011

(54) DATA STREAMING FOR INTERACTIVE DECISION-ORIENTED SOFTWARE APPLICATIONS

(76) Inventors: Jacob Guedalia, Newton, MA (US); Gavriel Raanan, Beit Shemesh (IL); Lawrence Reisler, Beit Shemesh (IL); Isaac David Guedalia, Beit Shemesh (IL)

(21) Appl. No.: 13/043,532

(22) Filed: Mar. 9, 2011

Related U.S. Application Data
(60) Provisional application No. 61/311,793, filed on Mar. 9, 2010.

(51) Int. Cl. G06F 9/445

(52) U.S. Cl. 717/175

(57) ABSTRACT

Providing data to a computer software application by intercepting a request made by a computer software application to retrieve a first data set from a first data storage location, accessing a record, defined in advance of the request, that includes a reference to the first data set and a reference to a second data set, retrieving the first data set from a data storage location other than the first data storage location, and retrieving the second data set from a data storage location other than the first data storage location in advance of a request by the computer software application to access the second data set at the first data storage location.

### CROSS-REFERENCE TO RELATED APPLICATIONS

This application claims priority benefit from U.S. Provisional Patent Application No. 61/311,793, filed Mar. 9, 2010, the disclosure of which is incorporated herein by reference in its entirety.

### FIELD OF THE INVENTION

The present invention relates to data streaming in general, and more particularly to data streaming for interactive, decision-oriented software applications.

### BACKGROUND OF THE INVENTION

Current data streaming methods enable a computer user to view or listen to a portion of video or music data file while downloading subsequent portions of file. However, existing streaming methods cannot be used to download an interactive software application, such as a computer game, where the entire application must be downloaded to the user's computer before the game can be played.

### SUMMARY OF THE INVENTION

In one aspect of the invention a method is provided for providing data to a computer software application, the method including intercepting a request made by a computer software application to retrieve a first data set from a first data storage location, accessing a record, defined in advance of the request, that includes a reference to the first data set and a reference to a second data set, retrieving the first data set from a data storage location other than the first data storage location, and retrieving the second data set from a data storage location other than the first data storage location in advance of a request by the computer software application to access the second data set at the first data storage location.

In another aspect of the invention the intercepting includes preventing an operating system of a computer that is executing the computer software application from attending to the request.

In another aspect of the invention the retrieving of the first data set is performed if the first data set is not available to be retrieved from the first data storage location.

In another aspect of the invention the method further includes storing at the first data storage location any of the data sets retrieved from any location other than the first data storage location.

In another aspect of the invention the method further includes allowing an operating system of a computer that is executing the computer software application to attend to the request if the first data set is available to be retrieved from the first data storage location.

In another aspect of the invention any of the retrieving steps are performed in accordance with a predefined rule associated with the record.

In another aspect of the invention the rule indicates that a first portion of a selected one of the data sets is to be retrieved, and that a second portion of the selected one of the data sets is to be retrieved only after the computer software application has received the first portion.

In another aspect of the invention the rule indicates preventing an operating system of a computer that is executing the computer software application from attending to the request prior to retrieving the first data set from the data storage location other than the first data storage location, and allowing the operating system to attend to the request subsequent to retrieving the second data set from the data storage location other than the first data storage location.

In another aspect of the invention a system is provided for providing data to a computer software application, the system including an interceptor configured to intercept a request made by a computer software application to retrieve a first data set from a first data storage location, and a manager configured to access a record, defined in advance of the request, that includes a reference to the first data set and a reference to a second data set, retrieve the first data set from a data storage location other than the first data storage location, and retrieve the second data set from a data storage location other than the first data storage location in advance of a request by the computer software application to access the second data set at the first data storage location.

In another aspect of the invention the interceptor is configured to prevent an operating system of a computer that is executing the computer software application from attending to the request.

In another aspect of the invention the manager is configured to retrieve the first data set if the first data set is not available to be retrieved from the first data storage location.

In another aspect of the invention the manager is configured to store at the first data storage location any of the data sets retrieved from any location other than the first data storage location.

In another aspect of the invention the interceptor is configured to allow an operating system of a computer that is executing the computer software application to attend to the request if the first data set is available to be retrieved from the first data storage location.

In another aspect of the invention the manager is configured to retrieve any of the data sets in accordance with a predefined rule associated with the record.

In another aspect of the invention the rule indicates that a first portion of a selected one of the data sets is to be retrieved, and that a second portion of the selected one of the data sets is to be retrieved only after the computer software application has received the first portion.

In another aspect of the invention the rule indicates that an operating system of a computer that is executing the computer software application is to be prevented from attending to the request prior to retrieving the first data set from the data storage location other than the first data storage location, and that the operating system is to be allowed to attend to the request subsequent to retrieving the second data set from the data storage location other than the first data storage location.

In another aspect of the invention a method is provided for preparing a software application for execution by a computer, the method including creating a set of core files including a plurality of computer files associated with a computer software application, executing the computer software application on a computer by executing any of the core files, recording requests made by the computer software application for data from a set of data files associated with the computer software application, defining blocks of references to data in the set of data files including any of the recorded requests for data, defining rules for controlling the retrieval of data referred to by any of the blocks, and associating the rules with any of the blocks.

In another aspect of the invention the method further includes adding to the set of core files any computer file associated with the computer software application that is required for stable execution of the computer software application.

In another aspect of the invention the adding is performed if the execution of the computer software application fails.

In another aspect of the invention the creating includes including in the core set of files any computer files associated with the computer software application that provide processing logic for the computer software application.

### BRIEF DESCRIPTION OF THE DRAWINGS

The invention will be understood and appreciated more fully from the following detailed description taken in conjunction with the appended drawings in which:

FIG. 1A is a simplified conceptual illustration of a system for managing the execution of a software application, constructed and operative in accordance with an embodiment of the invention;

FIG. 1B is a simplified conceptual illustration of an implementation of manager 100 of FIG. 1A, constructed and operative in accordance with an embodiment of the invention;

FIGS. 2A and 2B, taken together, is a simplified flowchart illustration of an exemplary method of operation of the system of FIGS. 1A and 1B, operative in accordance with an embodiment of the invention;

FIGS. 3A and 3B, taken together, provide a simplified conceptual illustration of a system for preparing a software application for execution by a computer, constructed and operative in accordance with an embodiment of the invention; and

FIG. 4 is a simplified flowchart illustration of an exemplary method of operation of the system of FIGS. 3A and 3B, operative in accordance with an embodiment of the invention.

### DETAILED DESCRIPTION OF THE INVENTION

The invention is now described within the context of one or more embodiments, although the description is intended to be illustrative of the invention as a whole, and is not to be construed as limiting the invention to the embodiments shown. It is appreciated that various modifications may occur to those skilled in the art that, while not specifically shown herein, are nevertheless within the true spirit and scope of the invention.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical data storage device, a magnetic data storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

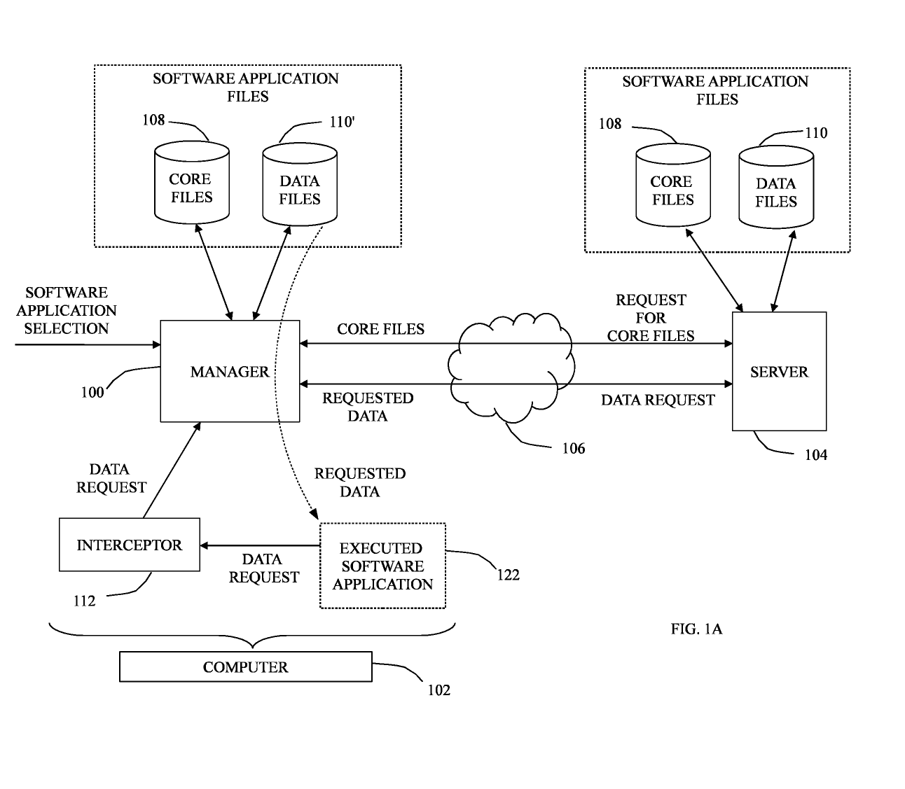

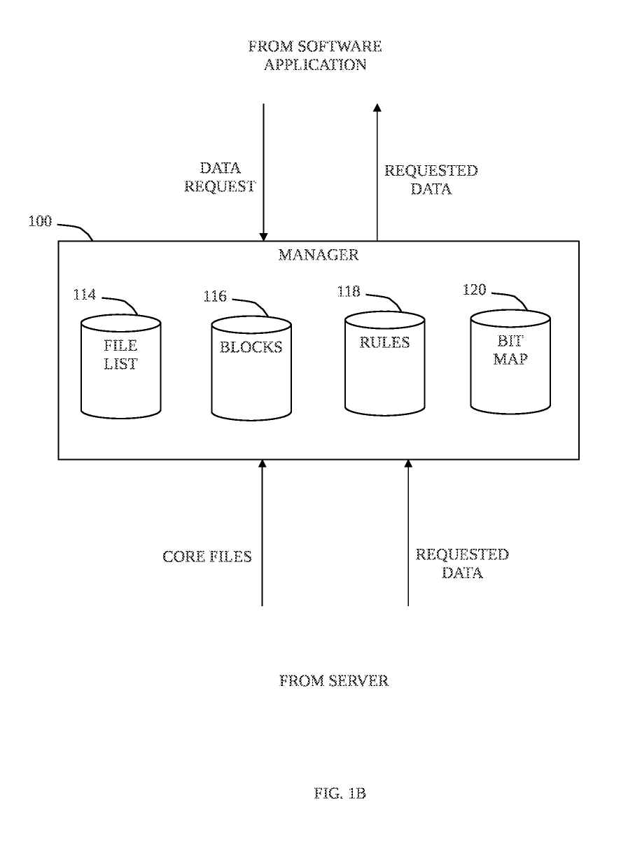

Reference is now made to FIG. 1A, which is a simplified conceptual illustration of a system for managing the execution of a software application, constructed and operative in accordance with an embodiment of the invention. In the system of FIG. 1A, a computer 102 is configured with a manager 100 that enables a user of computer 102 to indicate to manager 100, using any known technique, a software application, such as a computer-based game, for execution by computer 102. Manager 100 preferably determines if the software application is ready to be executed on computer 102, such as where manager 100 previously installed the software application for execution by computer 102 as described in greater detail hereinbelow, and executes the application if it is ready to be executed. If the software application is not ready to be executed by computer 102, manager 100 preferably retrieves a predefined portion of the software application, such as from local data storage media, and/or by downloading the predefined portion of the software application from a server 104, such as via a communications network 106, such as the Internet. As is described in greater detail hereinbelow, the predefined portion of the software application is preferably in the form of one or more computer files in a set of core files 108, where the software application is made up of core files 108 and a set of data files 110 that is stored on server 104. Manager 100 then installs the software application for execution by computer 102, preferably by creating on a local data storage device that is accessible to computer 102 a predefined directory structure that is required by the software application and placing the files of core files 108 into predefined locations within the directory structure. Manager 100 also preferably creates a set of placeholder files 110′ within the directory structure, such as by using SparseFiles™ API for Microsoft Windows™, where each placeholder file in set 110′ corresponds to a file in data files 110. The directory structure, file locations within the directory structure, and the names and sizes of the files in data files 110 are preferably known in advance to manager 100 or are otherwise acquired by manager 100 using conventional techniques, such as from local data storage media and/or from server 104. Once installed, manager 100 preferably initiates the execution of the software application by computer 102, such as by executing one of core files 108 that is predefined to cause the execution of the software application, thereby creating an instance of an executed software application 122.

Computer 102 also preferably includes an interceptor 112 that is configured to intercept requests made by executed software application 122 to retrieve data from placeholder files 110′, preferably where interceptor 112 prevents the operating system of computer 102 from processing the request, such as by withholding the request from the operating system. Interceptor 112 then forwards the request to manager 100. When manager 100 receives a request for data from interceptor 112, manager 100 determines whether the requested data are present within placeholder files 110′. If the requested data are present within placeholder files 110′, manager 100 allows executed software application 122 to retrieve the requested data from placeholder files 110′, preferably by allowing the operating system of computer 102 to process the request, such as by forwarding the request to the operating system or instructing interceptor 112 to forward the request to the operating system. If the requested data are not present within placeholder files 110′, manager 100 retrieves the requested data from their location(s) within data files 110, and places the retrieved data into their corresponding location(s) within placeholder files 110′. Manager 100 then allows executed software application 122 to retrieve the requested data from placeholder files 110′, such as is described above. Manager 100 may also retrieve other data from data files 110 in advance of requests by executed software application 122 to retrieve such data, as is described hereinbelow in greater detail.

Reference is now made to FIG. 1B, which is a simplified conceptual illustration of an implementation of manager 100 of FIG. 1A, constructed and operative in accordance with an embodiment of the invention. In the system of FIG. 1B, manager 100 preferably includes a file list 114 of the computer files that make up a software application that is managed by manager 100 as described herein, where file list 114 preferably indicates whether a file is one of core files 108 or one of data files 110. Manager 100 also preferably includes a set of block definitions 116 having multiple named records referred to as “blocks,” where each block includes one or more references to data within data files 110. Manager 100 also preferably includes a set of rules 118, where each rule is associated with a block and determines if and how data that are referred to in the block, or in one or more other blocks, are to be downloaded from data files 110, whereupon the data that are retrieved from data files 110 are placed by manager 100 in placeholder files 110′. Manager 100 also preferably maintains a record of the data that have been retrieved and placed in placeholder files 110′, such as by maintaining a bitmap 120 indicating locations within placeholder files 110′ to which retrieved data were written. Any of the file, block, and rule data described hereinabove are preferably known in advance to manager 100 or are otherwise acquired by manager 100 using conventional techniques, such as from local data storage media and/or from server 104.

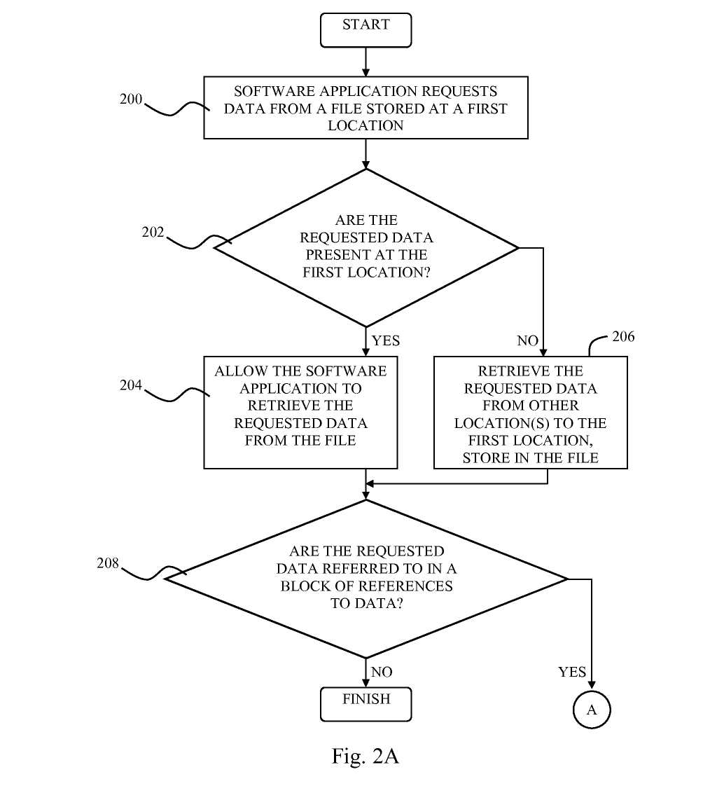

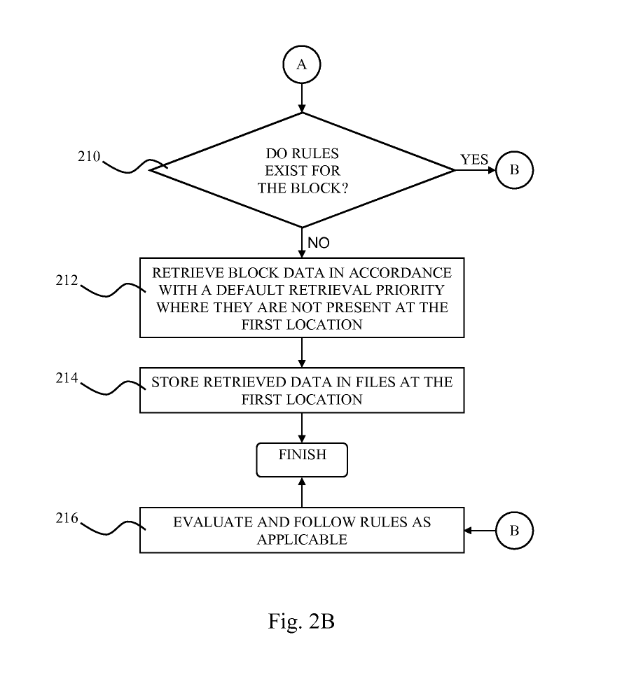

Reference is now made to FIGS. 2A and 2B, which, taken together, is a simplified flowchart illustration of an exemplary method of operation of the system of FIGS. 1A and 1B, operative in accordance with an embodiment of the invention. In the method of FIGS. 2A and 2B, a request made by a software application during its execution by a computer is received or is otherwise detected, where the request is to retrieve data from a file stored at a first location (step 200), preferably on a data storage device that is locally accessible to the computer. The name of the file, and typically the location of the requested data within the file, are specified as part of the request. If the requested data are present in the file (step 202), the software application is allowed to retrieve the requested data from the file, or the data are otherwise provided to the software application (step 204). If the requested data are not present in the file, the requested data are retrieved from one or more locations other than the first location, such as from a remote server where a copy of the requested data is stored and that is accessible via a communications network, and places the retrieved data into their corresponding location(s) within the file stored at the first location (step 206), whereupon the software application is allowed to retrieve the requested data from the file, or the data are otherwise provided to the software application (step 204).

If the requested data are referred to in a predefined block that includes one or more references to data that are associated with the software application (step 208), and if the block has no predefined rules associated with it (step 210), then the data referred to in the block are preferably retrieved in accordance with a default retrieval priority where they are not present at the first location (step 212), such as by retrieving the data from the remote server. The retrieved data are then stored in predefined locations within corresponding files stored at the first location (step 214). If the block has one or more predefined rules associated with it, then the rules are evaluated and followed where applicable (step 216), such as where the rules indicate that data referred to in the block, and/or in one or more other blocks, are to be retrieved, and at what retrieval priority. A description of examples of such rules and their application now follows.

Where the data referred to in a block are to be retrieved as described hereinabove, the block may be logically placed in a priority queue together with an indicator of a retrieval priority, such as an integer between 1 and 9, where 1 indicates the highest level of retrieval priority. Data referred to in higher priority blocks in the priority queue are preferably retrieved before data referred to in lower priority blocks unless otherwise indicated by a rule. Data referred to in multiple blocks with equal priority are preferably retrieved in a round-robin fashion. Rules associated with a block may affect the priority queue as follows:
by adding any block including itself to the priority queue with an integer priority level;
by modifying the priority of a block already in the queue by a certain positive or negative offset;
by removing blocks from the priority queue based on full or partial block name matches (wildcards), or based on priority level (greater than, less than, or equal to a threshold value);
by setting a buffering threshold for a block, such that if a predefined amount of data referred to in the block has been retrieved and is and ready for use by the software application, the priority queue will temporarily stop retrieving data referred to in the block and allow data to be retrieved for other blocks in the priority queue, even if they have a lower retrieval priority, until a predefined amount of the retrieved data referred to in the block has been provided to the software application, whereupon data retrieval for the block may resume.

Other types of rules associated with a block may include rules that:
cause a progress bar to appear during data retrieval, where the progress bar tracks the progress of the retrieval of data referred to by one or more specified blocks;
when a request is received from the software application for data that are referred to in a block, and the data are already present, withholds the data from the software application until the data referred to by one or more specified blocks have been completely retrieved.

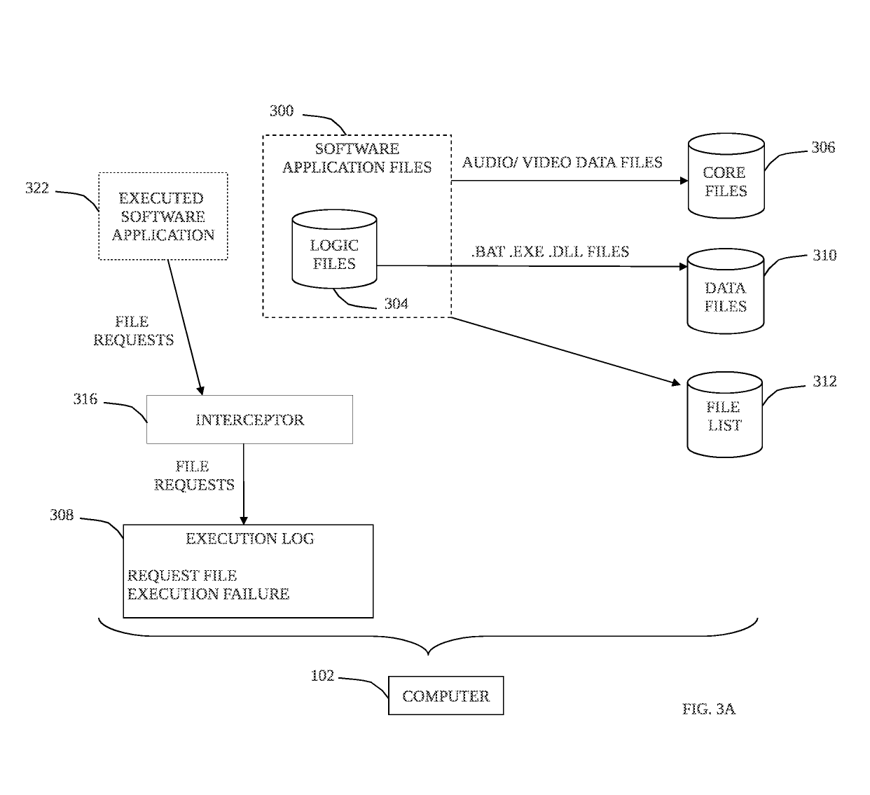

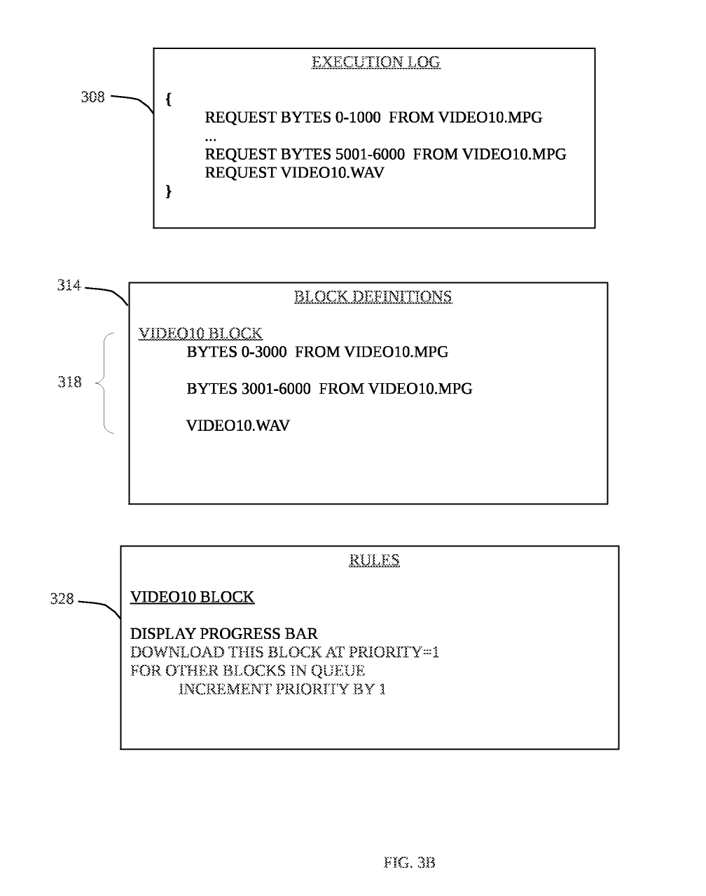

Reference is now made to FIGS. 3A and 3B, which, taken together, provide a simplified conceptual illustration of a system for preparing a software application for execution by a computer, constructed and operative in accordance with an embodiment of the invention. The system of FIGS. 3A and 3B may be used to prepare a software application for execution as described hereinabove. In FIG. 3A, a software application 300, such as a computer-based game, is preferably installed on a computer 302 using conventional methods. Application 300 preferably includes one or more files that provide processing logic for application 300 that are added to a set of core files 306, such as files with names that include suffixes such as ‘.exe’, ‘.dll’, or ‘.bat’. Application 300 also preferably includes one or more data files 310, which may include files such as audio files, video files, and any other files not in core files 306 that are used by application 300 when it is executed. The execution of application 300 is preferably initiated at computer 302, such as by executing one of core files 306 that is predefined to cause the execution of the application 300, thereby creating an instance of an executed software application 322. An execution log 308 is created in accordance with conventional techniques to record requests made by executed software application 322 for data from any of the files in data files 310, such as by configuring an interceptor 316 to intercept the requests and record the requests in log 308. If the execution fails, such as due to a request by executed software application 322 for a file in application 300 that was not included in core files 306, the file is preferably added to core files 306. This process is preferably repeated until core files 306 includes files of application 300 that, when executed, do not cause execution to fail, such as when their execution reaches a steady state, such as waiting for user input or requesting and waiting for data from data files 310. Data files 310 will typically include any other files that are used by application 300 when it is executed and that are not included in core files 306. A file list 312 of the files included in core files 306 and in data files 310 is preferably maintained.

As shown in FIG. 3B, block definitions set 314 is defined that includes one or more blocks of references to the requested data in data files 310. The blocks are preferably defined in a manner that groups logically related data, such as data that are requested from one or more files in data files 310 at a given point during the execution of application 300, or data that are requested sequentially from multiple files in data files 310 during a given execution interval of application 300. A block may be defined by a human operator by marking portions of log 308. For example, the operator may place a ‘{’ in log file 308 before the first request for data from a video file named “video10.mpg”, and a ‘}’ after the last request for data from the video file. References to the requested data that appear between the ‘{’ and ‘}’ markers in log 308 may then be used to define a block 318. Additional optimizing techniques may be applied when defining a block, such as by dividing block 318 into two smaller blocks, one that includes references to audio data portions of “video10.mpg”, and one that includes references to video data portions of “video10.mpg”. Since the video data portions of a multimedia file are typically much larger than the audio data portions, the block that includes references to video data portions of “video10.mpg” may be further divided into two or more blocks. A set of rules 328 is shown, in which rules may be associated with specific blocks and defined for controlling block-related behavior as described hereinabove.

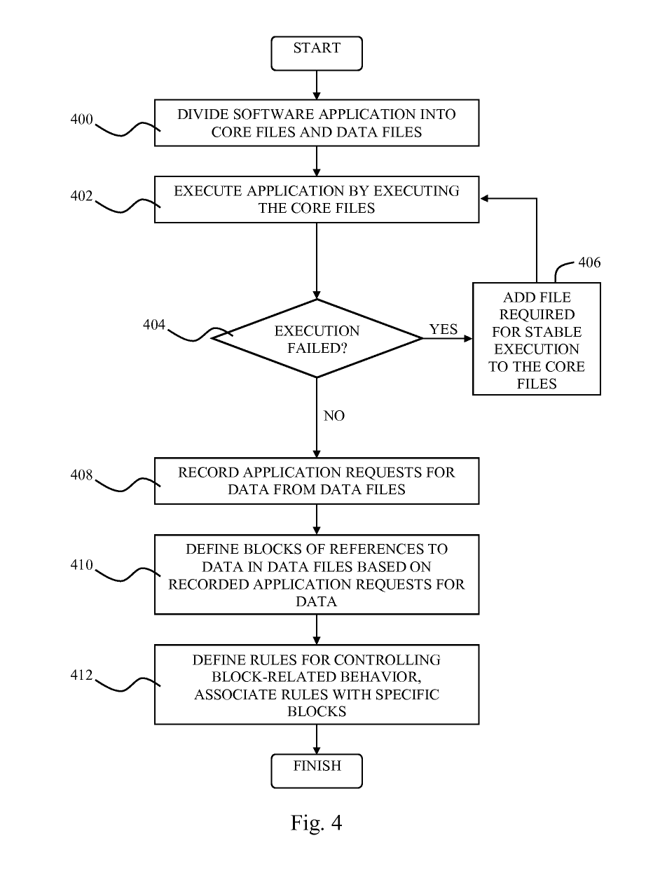

Reference is now made to FIG. 4, which is a simplified flowchart illustration of an exemplary method of operation of the system of FIGS. 3A and 3B, operative in accordance with an embodiment of the invention. In the method of FIG. 4, a software application is divided into core files and data files (step 400). The application is executed by executing the core files (step 402). If the execution fails (step 404) due to the absence of a file from the core files, the file is removed from the data files and added to core files (step 406). This process is preferably repeated until the core files includes those application files that, when executed, do not cause execution to fail, such as when their execution reaches a steady state, such as waiting for user input or requesting and waiting for data from the data files. Requests made by the application for data from any of the data files are recorded (step 408). One or more blocks are defined, where a block includes one or more references to data in the data files that are requested by the application (step 410). Rules are defined for controlling block-related behavior and are associated with specific blocks (step 412).

The system of FIGS. 3A and 3B and the method of FIG. 4 may be modified to optimize data retrieval efficiency from the server, such as by packaging together multiple data segments that may be referred to within the same block but may not necessarily reside in physically adjacent locations within the same data file. Data may also be stored in a compressed manner on the server. Multiple versions of audio and video files may be stored on the server, where each version of the same file is of a different quality, such that a smaller, lower-quality version of a file may be provided initially by the server, with a larger, higher-quality version being provided later.

The flowchart and block diagrams in the Figures illustrate the architecture, functionality, and operation of possible implementations of systems, methods and computer program products according to various embodiments of the invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It will be appreciated that any of the elements described hereinabove may be implemented as a computer program product embodied in a computer-readable medium, such as in the form of computer program instructions stored on magnetic or optical storage media or embedded within computer hardware, and may be executed by or otherwise accessible to a computer (not shown).

While the methods and apparatus herein may or may not have been described with reference to specific computer hardware or software, it is appreciated that the methods and apparatus described herein may be readily implemented in computer hardware or software using conventional techniques.

While the invention has been described with reference to one or more specific embodiments, the description is intended to be illustrative of the invention as a whole and is not to be construed as limiting the invention to the embodiments shown. It is appreciated that various modifications may occur to those skilled in the art that, while not specifically shown herein, are nevertheless within the true spirit and scope of the invention.

What is claimed is:

1. A method for providing data to a computer software application, the method comprising:
intercepting a request made by a computer software application to retrieve a first data set from a first data storage location;
accessing a record, defined in advance of the request, that includes a reference to the first data set and a reference to a second data set;
retrieving the first data set from a data storage location other than the first data storage location; and
retrieving the second data set from a data storage location other than the first data storage location in advance of a request by the computer software application to access the second data set at the first data storage location.

2. The method according to claim 1 where the intercepting comprises preventing an operating system of a computer that is executing the computer software application from attending to the request.

3. The method according to claim 1 where the retrieving of the first data set is performed if the first data set is not available to be retrieved from the first data storage location.

4. The method according to claim 1 and further comprising storing at the first data storage location any of the data sets retrieved from any location other than the first data storage location.

5. The method according to claim 1 and further comprising allowing an operating system of a computer that is executing the computer software application to attend to the request if the first data set is available to be retrieved from the first data storage location.

6. The method according to claim 1 where any of the retrieving steps are performed in accordance with a predefined rule associated with the record.

7. The method according to claim 7 where the rule indicates that a first portion of a selected one of the data sets is to be retrieved, and that a second portion of the selected one of the data sets is to be retrieved only after the computer software application has received the first portion.

8. The method according to claim 7 where the rule indicates preventing an operating system of a computer that is executing the computer software application from attending to the request prior to retrieving the first data set from the data storage location other than the first data storage location, and allowing the operating system to attend to the request subsequent to retrieving the second data set from the data storage location other than the first data storage location.

9. A system for providing data to a computer software application, the system comprising:
an interceptor configured to intercept a request made by a computer software application to retrieve a first data set from a first data storage location; and
a manager configured to
access a record, defined in advance of the request, that includes a reference to the first data set and a reference to a second data set,
retrieve the first data set from a data storage location other than the first data storage location, and
retrieve the second data set from a data storage location other than the first data storage location in advance of a request by the computer software application to access the second data set at the first data storage location.

10. The system according to claim 9 where the interceptor is configured to prevent an operating system of a computer that is executing the computer software application from attending to the request.

11. The system according to claim 9 where the manager is configured to retrieve the first data set if the first data set is not available to be retrieved from the first data storage location.

12. The system according to claim 9 where the manager is configured to store at the first data storage location any of the data sets retrieved from any location other than the first data storage location.

13. The system according to claim 9 where the interceptor is configured to allow an operating system of a computer that is executing the computer software application to attend to the request if the first data set is available to be retrieved from the first data storage location.

14. The system according to claim 9 where the manager is configured to retrieve any of the data sets in accordance with a predefined rule associated with the record.

15. The system according to claim 15 where the rule indicates that a first portion of a selected one of the data sets is to be retrieved, and that a second portion of the selected one of the data sets is to be retrieved only after the computer software application has received the first portion.

16. The system according to claim 15 where the rule indicates that an operating system of a computer that is executing the computer software application is to be prevented from attending to the request prior to retrieving the first data set from the data storage location other than the first data storage location, and that the operating system is to be allowed to attend to the request subsequent to retrieving the second data set from the data storage location other than the first data storage location.

17. A method for preparing a software application for execution by a computer, the method comprising:
creating a set of core files including a plurality of computer files associated with a computer software application;
executing the computer software application on a computer by executing any of the core files;
recording requests made by the computer software application for data from a set of data files associated with the computer software application;
defining blocks of references to data in the set of data files including any of the recorded requests for data;
defining rules for controlling the retrieval of data referred to by any of the blocks; and
associating the rules with any of the blocks.

18. The method according to claim 17 and further comprising adding to the set of core files any computer file associated with the computer software application that is required for stable execution of the computer software application.

19. The method according to claim 18 where the adding is performed if the execution of the computer software application fails.

20. The method according to claim 17 where the creating comprises including in the core set of files any computer files associated with the computer software application that provide processing logic for the computer software application.
